(19) United States
(12) Patent Application Publication
(10) Pub. No.: US 2006/0216553 A1
(43) Pub. Date: Sep. 28, 2006

(54) Fuel cell with bipolar plates having micro channels and its manufacturing method

(76) Inventors: Shuo-Jen Lee, Taipei City (TW); Yu-Pang Chen, Yangmei Township (TW); Ching-Han Huang, Bade City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/385,815

(22) Filed: Mar. 22, 2006

(30) Foreign Application Priority Data
Mar. 28, 2005 (TW) 094109671

(51) Int. Cl. H01M 8/00

(52) U.S. Cl. 429/12

(57) ABSTRACT

A fuel cell with bipolar plates having micro channels and its manufacturing method are disclosed. The structure of this fuel cell includes a pair of bipolar plates and a catalytic portion. The bipolar plate has a gas inlet, a gas outlet, a main channel, several blocking portions, and many micro channels formed on the blocking portions and connecting two adjacent sections of the main channel. The manufacturing method includes (1) preparing step, (2) first-layer structure manufacturing step, (3) second-layer structure manufacturing step, and (4) complete step. It can increase the gas contacting area. It can drain off water more effectively. It is suitable for mass production.

### BACKGROUND OF INVENTION

1. Field of the Invention

The present invention relates to a fuel cell with bipolar plates having micro channels and its manufacturing method. Particularly, it relates to a fuel cell with bipolar plates having micro channels between adjacent sections of a curvy main channel and its manufacturing method. It can increase the gas contacting area. It can drain off water more effectively. It is suitable for mass production.

2. Description of the Prior Art

The basic principle of a fuel cell is to utilize a membrane electrode assembly (or briefly referred as MEA) having a catalytic layer to conduct an electrochemical reaction for hydrogen and oxygen. This MEA is disposed between a pair of bipolar plates. During this electrochemical reaction, water and electricity are produced. Therefore, it is desired to design the bipolar plates with larger contacting area for gases and with excellent ability to drain off water. In addition, it has to consider other factors like proper pressure difference between the entrance and the exit, the flow field distribution, the smoothness about the flowing path, the supplying volume for fuel gases (hydrogen and oxygen), the temperature control, draining off design, etc. So, the entire electricity generating efficiency for this fuel cell can be raised.

There are many kinds of flowing channels inside the traditional bipolar plates, such as parallel branch type, snake-like curvy type, penetrating-type, etc. If the size of one bipolar plate is 10×10 cm, it will have an area of 100 cm². As shown in FIGS. 1 and 2, assuming it is the snake-like curvy type, the length of this flowing channel might reach 50 cm. These bipolar plates include a positive plate 81 and a negative plate 82 (plus a membrane electrode assembly namely the MEA that is disposed between them). A first snake-like curvy channel 811 and a second snake-like curvy channel 821 are disposed on the positive plate 81 and the negative plate 82 respectively. If the first snake-like curvy channel 811 is placed along a horizontal direction, then the second snake-like curvy channel 821 should be placed along a vertical direction. Thus, these channels will be substantially intersected each other. Once the positive plate 81 and the negative plate 82 are assembled, it will form many overlapping zones 83. These overlapping zones 83 are separated but they are evenly distributed. However, the ratio of the total area of all these overlapping zones 83 over the area of one bipolar plate is still low (probably below 25% in this case, just an estimate). So, it is its major disadvantage.

Second, water generated by the electrochemical reaction in the fuel cell tends to accumulate on the top surfaces of the dividing portions 812, 822 (surround by first snake-like curvy channel 811 and the second snake-like curvy channel 821 respectively). If water accumulates too much and does not be guided out immediately, it will gradually block the channel. Also, the efficiency of the fuel cell will decrease.

Moreover, the manufacturing method of the traditional fuel cell with bipolar plates having micro channels is to produce a structure with only one channel by a traditional light-hardening technology. The total area of the overlapping zones is relatively small. Hence, it also has the same problem mentioned above.

### SUMMARY OF THE INVENTION

The primary object of the present invention is to provide a fuel cell with bipolar plates having micro channels and its manufacturing method. It can increase the gas contacting area.

The next object of the present invention is to provide a fuel cell with bipolar plates having micro channels and its manufacturing method. It can drain off water more effectively.

Another object of the present invention is to provide a fuel cell with bipolar plates having micro channels and its manufacturing method. It is suitable for mass production.

In order to achieve above-mentioned objects, the present invention is provided. It relates to a fuel cell with bipolar plates having micro channels and its manufacturing method. About the structure, it comprises:

a pair of bipolar plates and an catalytic portion therebetween; each bipolar plate including:
a gas inlet;
a gas outlet;
a main channel communicating said gas inlet and said gas outlet, said main channel having a first cross-sectional area, said main channel having several sections;

a plurality of blocking portions by two sides of each section of said main channel;

a plurality of micro channels formed on said blocking portions and connecting two adjacent sections of said main channel, each micro channel having a second cross-sectional area, said second cross-sectional area being smaller than said first cross-sectional area.

Regarding its manufacturing method, it includes the steps of:

(1) preparing step;

(2) first-layer structure manufacturing step;

(3) second-layer structure manufacturing step; and

(4) complete step.

### BRIEF DESCRIPTION OF THE DRAWINGS

FIG. 1 is a view showing the traditional fuel cell structure.

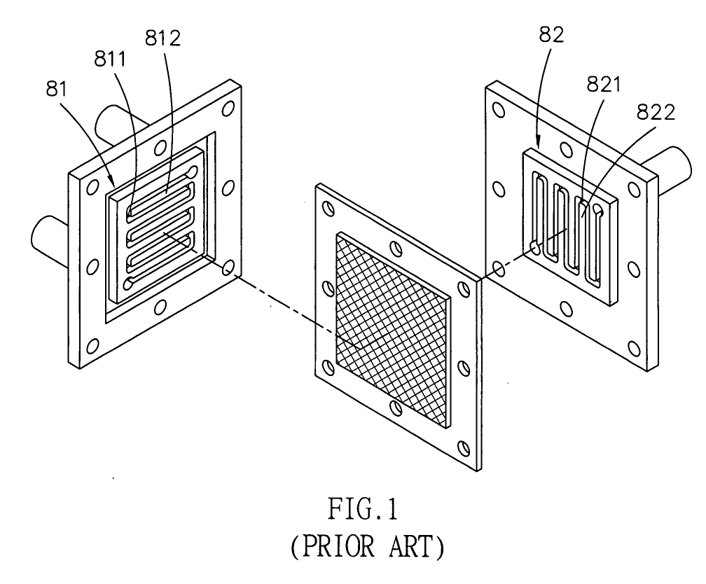

FIG. 2 is a view showing the inner structure of the traditional fuel cell when it is assembled.

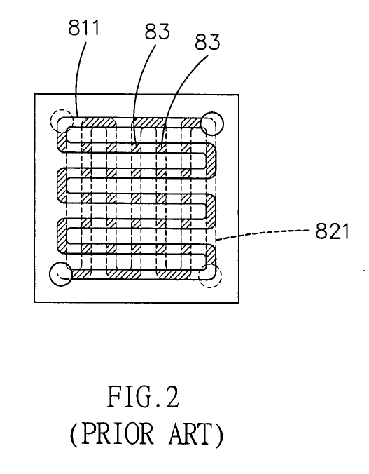

FIG. 3 is a perspective view illustrating the present invention.

FIG. 4 is an enlarged view for a selected portion of this invention.

FIG. 5 is another enlarged view showing another selected portion of this invention.

FIG. 6 shows a second preferred embodiment of the present invention.

FIG. 7 is an enlarged view of a selected portion of the second preferred embodiment.

FIG. 8 is a flow chart showing the manufacturing method of this invention.

FIGS. 9A, 9B, 9C, 9D, 9E, 9F, 9G and 9H show the manufacturing processes of this invention.

FIG. 10 is another flow chart about this invention.

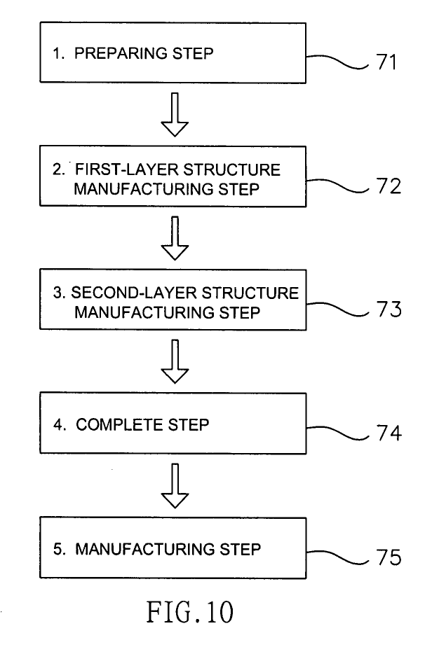

FIG. 11 illustrates a mold required in the manufacturing method of this invention for mold injection.

### DETAILED DESCRIPTION OF THE PREFERRED EMBODIMENT

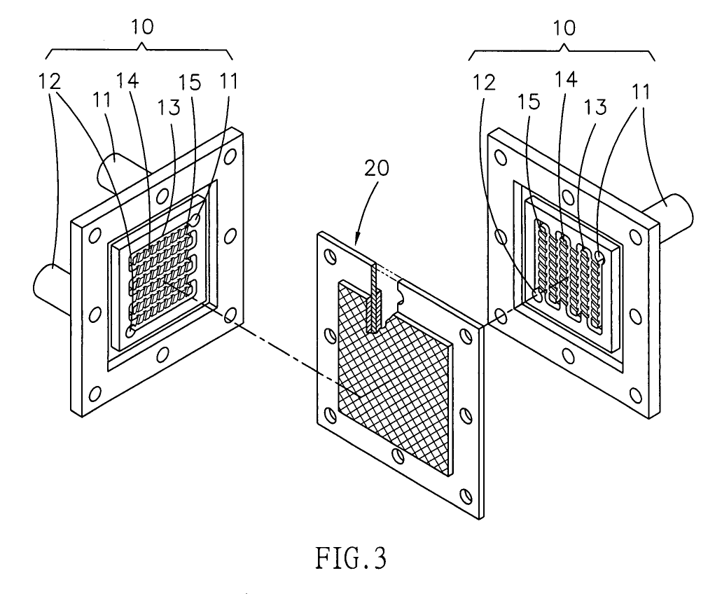

The present invention relates to a fuel cell with bipolar plates having micro channels and its manufacturing method. Referring to FIG. 3, the structure of this invention basically includes a pair of bipolar plates 10 and a catalytic portion 20 therebetween.

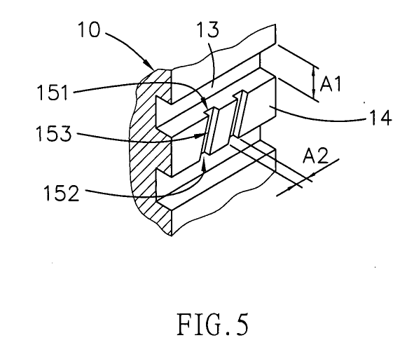

With regard to the bipolar plates 10, each bipolar plate 10 includes:
a gas inlet 11;
a gas outlet 12;
a main channel 13 communicating the gas inlet 11 and the gas outlet 12; the main channel 13 having a first cross-sectional area A1 (as shown in FIG. 5) and the main channel 13 having several sections;
a plurality of blocking portions 14 by two sides of each section of the main channel 13;
a plurality of micro channels 15 formed on the blocking portions 14 and connecting two adjacent sections of the main channel 13; each micro channel 15 having a second cross-sectional area A2 (as shown in FIG. 5); the second cross-sectional area A2 being smaller than the first cross-sectional area A1.

About the catalytic portion 20, it is a membrane electrode assembly (or referred as MEA) that contains a catalytic layer (for electrochemical reaction between hydrogen and oxygen).

This catalytic portion 20 is sandwiched by this pair of bipolar plates 10. Hydrogen is supplied from the gas inlet 11 of one bipolar plate 10. Oxygen is supplied from another gas inlet 11 of the other bipolar plate 10. Therefore, hydrogen and oxygen flow in the main channels 13 of these two bipolar plates 10 respectively. By contacting the catalytic portion 20, an electrochemical reaction occurs and then water and electricity are generated.

That is, when hydrogen and oxygen flow in different main channels 13, the electrochemical reaction occurs via the catalytic portion 20.

Meanwhile, electricity and water are generated.

In order to prolong the staying time when the gas flows through for producing more electricity, the main channel 13 is designed as a snake-like curvy flowing path. Of course, the generated electricity can be guided out directly for other application or use.

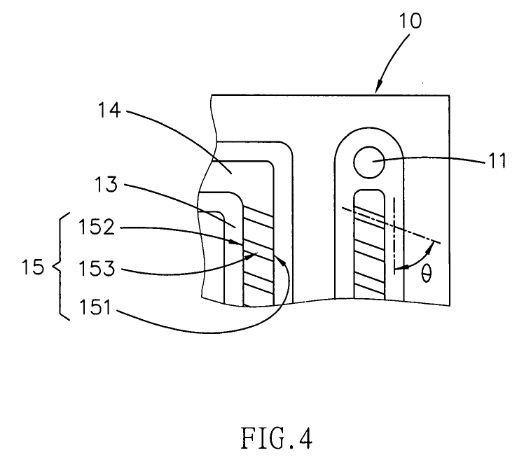

As illustrated in FIGS. 4 and 5, there is a plurality of micro channels 15 substantially parallel each other on each blocking portion 14. Every micro channel 15 has a guide-in port 151, a flow-out port 152, and a main guiding channel 153 (as shown in FIGS. 4 and 5).

Every micro channel 15 communicates two adjacent sections of the main channel 13. And, the second cross-sectional area A2 of the micro channel 15 is smaller than the first cross-sectional area A1. Due to this design, the main stream of gas tends to stay in the longer and wider main channel 13. It also prolongs the staying time of the gas between these pair of bipolar plates 15. Also, it can increase the possibility for generating the electrochemical reaction and its electricity.

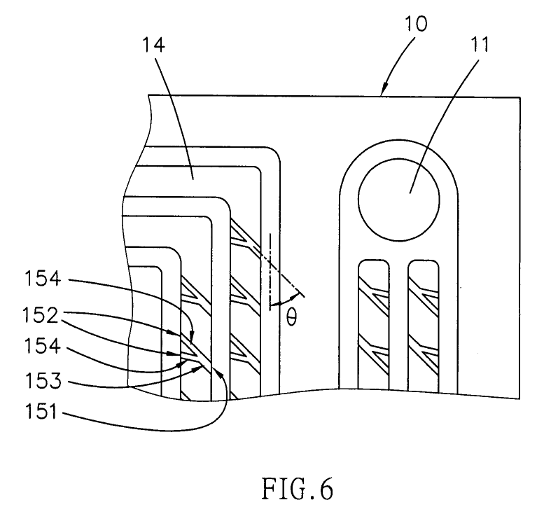

Water is generated by the electrochemical reaction between hydrogen and oxygen. The flowing gas in the long and curvy main channel 13 takes away most droplets of water. Some water will be guided into the guide-in port 151 of any micro channel 15 and then be guided through the main guiding channel 153 formed on the blocking portion 14. Finally, water will flow out from the flow-out port 152 to another section of the main channel 13. In this preferred embodiment, there is an angle θ (roughly between 15 and 85 degrees) between the main guiding channel 153 and the main channel 13 (as illustrated in FIGS. 4 and 6).

Based on the design of micro channels 15 mentioned above, water will be drained off by the main channel 15 due to the faster flowing speed and relatively lower pressure in the main channel 13. Hence, such lower pressure is helpful to take away the water stayed in these micro channels 15.

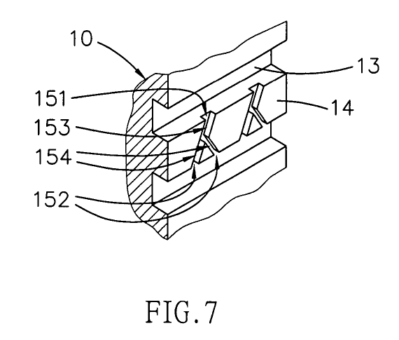

As shown in FIGS. 6 and 7, it is the second preferred embodiment of the present invention. Each micro channel 15 has one guide-in port 151, several flow-out ports 152, and one main guiding channel 153 connecting the guide-in port 151, and several separated secondary guiding channels 154. The main guiding channel 153 connects with the main channel 13. Also, there is an angle θ (roughly between 15 and 85 degrees) between the main guiding channel 153 and the main channel 13. Because of the faster flowing speed and lower pressure in the main channel 13, it can force the water in the secondary guiding channel 154 to be drawn out.

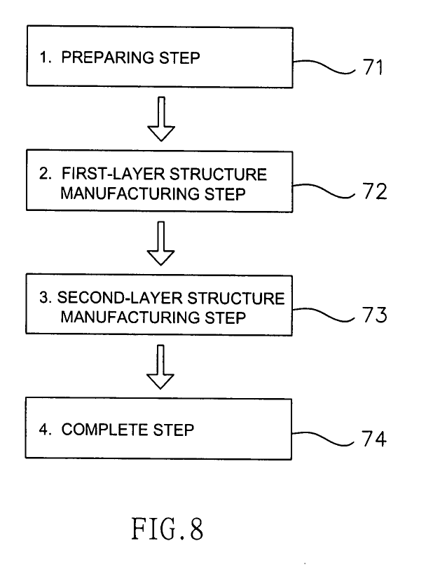

Referring to FIG. 8, the manufacturing method of the micro channels in this invention at least comprises the steps of:

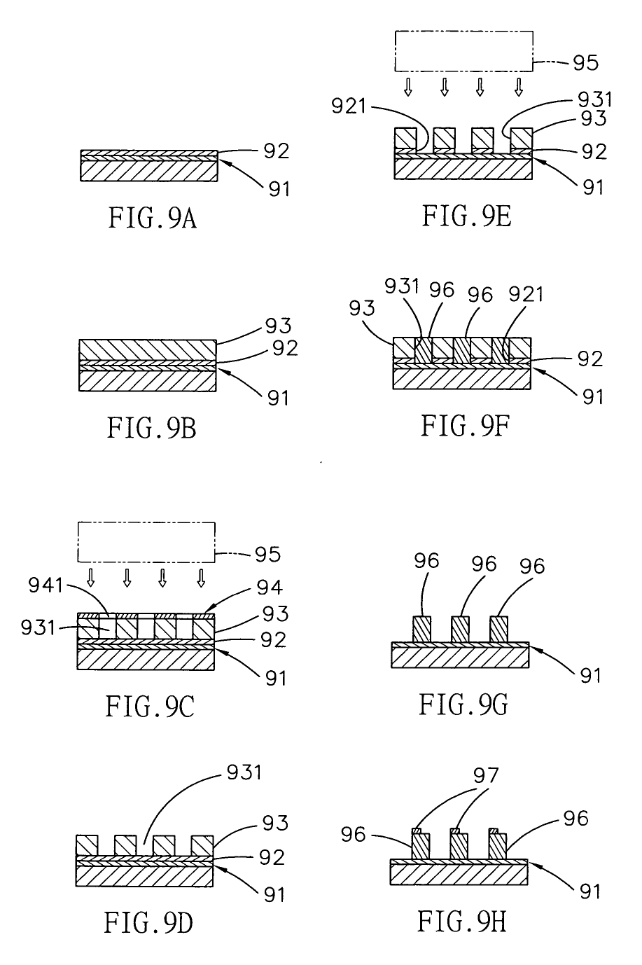

(1) preparing step 71: as shown in FIG. 9A, to prepare a base plate 1 and to form a first photoresist layer 92 on the base plate 91;

(2) first-layer structure manufacturing step 72: as illustrated in FIG. 9B, to form a second photoresist layer 93 on the first photoresist layer 92; as shown in FIG. 9C, to place a mask 94 having molding holes 941 on the second photoresist layer 93 and then to apply UV light to form molding cavities 931; to remove the mask 94 (as shown in FIG. 9D); as shown in FIG. 9E, to apply UV light again to the first photoresist layer 92 through the molding cavities 931 and then to form the molding slots 921; Next, as illustrated in FIG. 9F, to form a first-layer structure 96 by the molding slots 921 and the molding cavities 931, and finally to remove the first photoresist layer 92 and the second photoresist layer 93 (referring to FIG. 9G);

(3) second-layer structure manufacturing step 73: to use the first-layer structure 96 as another base plate and to repeat the steps mentioned in the first-layer structure manufacturing step 72;

(4) complete step 74: after finishing the second-layer structure manufacturing step 73 on the first-layer structure 96, a second-layer structure 97 is formed on the first-layer structure 96.

More specifically, after first-layer structure manufacturing step 72 is done, the curvy main channel 13 and the blocking portions 14 are made;

Once the second-layer structure manufacturing step 73 is done, these micro channels 15 (as shown in FIGS. 4 and 5) are formed on the blocking portions 14. Each micro channel 15 has one guide-in port 151, one flow-out port 152, and one main guiding channel 153 between the guide-in port 151 and the flow-out port 152. In the main channel 13, its flowing speed is faster and the pressure is lower. So, the water in the main guiding channels 153 will be quickly brought out by gas in the main channel 13. Also, there is an angle θ (roughly between 15 and 85 degrees) between the main guiding channel 153 and the main channel 13.

As illustrated in FIGS. 6 and 7, the micro channel 15 includes one guide-in port 151, several flow-out ports 152, one main guiding channel 153 connecting the guide-in port 151, and several separated secondary guiding channels 154. Thus, the main guiding channel 153 can communicate with the main channel 13. Also, there is an angle θ (roughly between 15 and 85 degrees) between the main guiding channel 153 and the main channel 13. Due to the same reasons of the faster flowing speed and lower pressure in the main channel 13, it can quickly bring out the water in the secondary guiding channel 154.

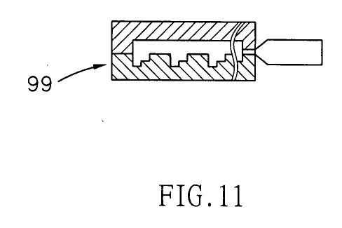

Of course, after finishing the complete step 74, the product can be obtained. In addition, a mold 99 (as shown in FIG. 11) can be applied to. Therefore, after the complete step 74, it further includes the step of:

(5) manufacturing step 75: by using the mold 99 to produce a product of fuel cell with bipolar plates having micro channels. Its manufacturing method can be the conventional plastic injection, heat-pressing molding, etc. That is, the mold 99 should be made first and then the product can be manufactured by the mold 99. Thus, it is suitable for mass production with lower costs.

The advantages and functions of this invention can be listed as follows:

[1] It can increase the gas contacting area. In this invention, a plurality of micro channels formed on the blocking portions. So, the hydrogen and oxygen not only can contact each other in the main channel, but also can in the micro channels. It significantly increases the possibility the contacting area between these two bipolar plates. Hence, it can generate more electricity by electrochemical reaction.

[2] It can drain off water more effectively. Because there are lots of micro channels connecting with the sections of this main channel, the water can be brought by the main channel or guided by these micro channels.

[3] It is suitable for mass production. This invention can be made directly. Or, by utilizing a mold, it can be made by existing mold injection technique. Hence, it is suitable for mass production. Of course, its cost can be lowered.

The above embodiments are only used to illustrate the present invention, not intended to limit the scope thereof. Many modifications of the above embodiments can be made without departing from the spirit of the present invention.

What is claimed is:

1. A fuel cell with bipolar plates having micro channels comprising a pair of bipolar plates and an catalytic portion therebetween; each bipolar plate including:
a gas inlet;
a gas outlet;
a main channel communicating said gas inlet and said gas outlet, said main channel having a first cross-sectional area, said main channel having several sections;
a plurality of blocking portions by two sides of each section of said main channel;
a plurality of micro channels formed on said blocking portions and connecting two adjacent sections of said main channel, each micro channel having a second cross-sectional area, said second cross-sectional area being smaller than said first cross-sectional area.

2. The fuel cell with bipolar plates having micro channels as claimed in claim 1, wherein each micro channel has a guide-in port, a flow-out port, and a main guiding channel between said guide-in port and said flow-out port, said main guiding channel communicates with said main channel.

3. The fuel cell with bipolar plates having micro channels as claimed in claim 2, wherein an angle θ roughly between 15 and 85 degrees is disposed between said main guiding channel and said main channel.

4. The fuel cell with bipolar plates having micro channels as claimed in claim 1, wherein the micro channel includes a guide-in port, several flow-out ports, a main guiding channel connecting said guide-in port, and several separated secondary guiding channels, and said main guiding channel communicates with said main channel.

5. The fuel cell with bipolar plates having micro channels as claimed in claim 4, wherein an angle θ roughly between 15 and 85 degrees is disposed between said main guiding channel and said main channel.

6. A manufacturing method of fuel cell with bipolar plates having micro channels comprising:
(1) preparing step: to prepare a base plate and to form a first photoresist layer on the base plate;
(2) first-layer structure manufacturing step: to form a second photoresist layer on said first photoresist layer; to place a mask having molding holes on said second photoresist layer and then to apply UV light to form molding cavities; to remove the mask; to apply UV light again to the first photoresist layer through the molding cavities and then to form the molding slots; Next, to form a first-layer structure by the molding slots and the molding cavities, and finally to remove the first photoresist layer and the second photoresist layer;
(3) second-layer structure manufacturing step: to use the first-layer structure as another base plate and to repeat the steps mentioned in the first-layer structure manufacturing step;
(4) complete step: after finishing the second-layer structure manufacturing step on the first-layer structure, a second-layer structure being formed on the first-layer structure.

7. The manufacturing method of fuel cell with bipolar plates having micro channels as claimed in claim 6, wherein
said second-layer structure forms a plurality of micro channels disposed on a plurality of blocking portions, each micro channel has a guide-in port, a flow-out port, and a main guiding channel between said guide-in port and said flow-out port, said main guiding channel communicates with said main channel.

8. The manufacturing method of fuel cell with bipolar plates having micro channels as claimed in claim 7, wherein an angle θ roughly between 15 and 85 degrees is disposed between said main guiding channel and said main channel.

9. The manufacturing method of fuel cell with bipolar plates having micro channels as claimed in claim 6, said second-layer structure forms a plurality of micro channels disposed on a plurality of blocking portions, each micro channel includes a guide-in port, several flow-out ports, a main guiding channel connecting said guide-in port, and several separated secondary guiding channels, and said main guiding channel communicates with said main channel.

10. The manufacturing method of fuel cell with bipolar plates having micro channels as claimed in claim 9, wherein an angle θ roughly between 15 and 85 degrees is disposed between said main guiding channel and said main channel.

11. A manufacturing method of fuel cell with bipolar plates having micro channels comprising:
(1) preparing step: to prepare a base plate and to form a first photoresist layer on the base plate;
(2) first-layer structure manufacturing step: to form a second photoresist layer on said first photoresist layer; to place a mask having molding holes on said second photoresist layer and then to apply UV light to form molding cavities; to remove the mask; to apply UV light again to the first photoresist layer through the molding cavities and then to form the molding slots; Next, to form a first-layer structure by the molding slots and the molding cavities, and finally to remove the first photoresist layer and the second photoresist layer;
(3) second-layer structure manufacturing step: to use the first-layer structure as another base plate and to repeat the steps mentioned in the first-layer structure manufacturing step;
(4) complete step: after finishing the second-layer structure manufacturing step on the first-layer structure, a second-layer structure being formed on the first-layer structure;
(5) manufacturing step: by using a mold to produce a product of fuel cell with bipolar plates having micro channels.

12. The manufacturing method of fuel cell with bipolar plates having micro channels as claimed in claim 11, wherein
said second-layer structure forms a plurality of micro channels disposed on a plurality of blocking portions, each micro channel has a guide-in port, a flow-out port, and a main guiding channel between said guide-in port and said flow-out port, said main guiding channel communicates with said main channel.

13. The manufacturing method of fuel cell with bipolar plates having micro channels as claimed in claim 12, wherein an angle θ roughly between 15 and 85 degrees is disposed between said main guiding channel and said main channel.

14. The manufacturing method of fuel cell with bipolar plates having micro channels as claimed in claim 11, wherein the micro channel includes a guide-in port, several flow-out ports, a main guiding channel connecting said guide-in port, and several separated secondary guiding channels, and said main guiding channel communicates with said main channel.

15. The manufacturing method of fuel cell with bipolar plates having micro channels as claimed in claim 14, wherein an angle θ roughly between 15 and 85 degrees is disposed between said main guiding channel and said main channel.
